(19) United States
(12) Patent Application Publication
(10) Pub. No.: US 2019/0368509 A1
(43) Pub. Date: Dec. 5, 2019

(54) HOUSING FOR HOLDING AN AIR PUMP, AN AIR PUMP, AND AN INFLATABLE DEVICE

(71) Applicants: Christos Koptsidis, Wijnegem (BE); Patrick Spaas, Bergen (NL)

(72) Inventors: Christos Koptsidis, Wijnegem (BE); Patrick Spaas, Bergen (NL)

(21) Appl. No.: 16/485,129

(22) PCT Filed: Feb. 10, 2017
(86) PCT No.: PCT/EP2017/053067

§ 371 Date: Aug. 9, 2019

(51) Int. Cl. F04D 29/60; F04D 25/08

(52) U.S. Cl. CPC F04D 29/603; F05D 2240/90; F04D 25/08

(57) ABSTRACT

A housing for an air pump is provided for being incorporated in an inflatable device. A housing body defines a holding space for the pump. A first opening in the body is provided for taking the pump in/out of the holding space. A second opening in the body is provided for forming a passage between the holding space and an inflatable volume of the inflatable device when the housing is incorporated in the inflatable device, and for being releasably connected to the pump in an airtight manner. The body includes a resilient securing member in the holding space for releasably securing the pump in the housing when the pump is arranged in a first position in the holding space. In the first position an air outlet of the pump is releasably connected to the second opening in an airtight manner.

### TECHNICAL FIELD

The invention relates to housing for holding an air pump, wherein the housing is provided for being incorporated in an inflatable device. The invention also relates to an air pump and air pump assembly for use with the housing. The invention also relates to an inflatable device in which the housing is incorporated, and an inflatable device assembly comprising the inflatable device and the pump.

### BACKGROUND ART

An inflatable device, such as an inflatable air mattress, an inflatable lounger, etc., may be provided with a housing for holding an air pump in a side wall of the inflatable device which surrounds an inflatable volume of the inflatable device. The housing holds the air pump in place when it is connected to an inlet of the inflatable device for inflating the inflatable device. In this way the inflatable device can be inflated by the air pump without requiring further manual intervention.

Such a housing or case for holding an air pump or air blower is for example known from US 2004/0261183 A1. Securing the air pump in the housing requires a separate securing element, i.e. a position plate, which needs to be clicked in a sliding seat provided on an inner side face of the housing in order to hold the air pump in the correct position within the housing. To release the air pump from the housing, the position plate has to be detached first from the sliding seat, and then moved out of the sliding seat before the air pump may be removed out of the housing. Because of the this complex mechanism, this housing has the disadvantage that it is difficult to quickly secure the air pump in the housing and to quickly release the air pump from the housing, and that it is difficult to manufacture and assemble. The position plate of this housing also has the disadvantage that it hinders the air flow towards the inlet of the air pump in the housing. The open housing also has the disadvantage that water may easily enter the housing, and damage the pump when an inflatable device with the housing is used on or near a water surface of, for example, a swimming pool.

### DISCLOSURE OF THE INVENTION

It is an aim of the invention to provide a housing for holding an air pump, in which the air pump is more easily secured and released.

It is a further aim of the invention to provide a housing for holding an air pump which is simple in design such that it easy to manufacture and use.

It is a further aim of the present invention to provide a housing for holding an air pump which is water proof.

This aim is achieved according to the invention with a housing for holding an air pump showing the technical characteristics of the first independent claim.

Therefore, the invention provides a housing for holding an air pump. The housing is provided for being incorporated in an inflatable device. The housing comprises a body defining a holding space for the air pump. The housing comprises a first opening in a first side face of the body. The first opening is provided for taking the air pump in and out of the holding space. The housing comprises a second opening in a second side face of the body. The second opening is provided for forming, when the housing is incorporated in the inflatable device, a passage between the holding space and an inflatable volume of the inflatable device. The second opening is provided for being releasably connected to the air pump in an airtight manner. The body comprises a resilient securing member in the holding space for releasably securing the air pump in the housing when the air pump is arranged in a first position in the holding space, in which first position an air outlet of the air pump is releasably connected to the second opening in an airtight manner.

It has been found that by providing a resilient securing member in the holding space has the advantage of easily securing the air pump in the desired position. The provision of the resilient securing member has a further advantage in that in that it forms part of the housing body, thus greatly simplifying the manufacturing and assembly process, in comparison to the devices of the prior art. Another advantage brought by the present invention, is that it greatly simplifies and speeds up the process of inflating and/or deflating an inflatable device, in comparison to the devices of the prior art. This is because, the pump can be positioned and removed from the housing by simply applying a force on the pump that is strong enough to overcome the resilient force applied by the securing member. For example, to secure the pump in the first position, the user may simply apply a push force on the pump that causes the resilient securing member to bend outwards, in the direction of the inner sidewalls of the housing body. Once the pump is in the desired position, the resilient securing member returns back to its original position, thereby securing the pump in the first position. Similarly, to remove the pump, the user may apply a pulling force on the pump, which bends outwards the resilient members, thereby allowing the pump to be removed from the housing. An additional advantage of the present invention, is that once the pump is secured in the desired position the pumping operation may be performed without any manual intervention.

In an embodiment of the housing according to the invention the housing the resilient securing member comprises at least one resilient securing element extending from the body inside the holding space. The at least one resilient securing element is positioned for gripping around the air pump when the air pump is arranged in the first position in the holding space.

It has been found that by providing the resilient securing member with at least one securing element that grips around the body of the pump, has the advantage of better securing the pump in the desired position during inflation and/or deflation of the inflatable device. The at least one securing element may be in the form of a clamp configured for clamping around the body of the pump, so that the pump is kept in the desired position during the inflation and/or deflation of the inflatable device.

In an embodiment of the housing according to the invention the housing the resilient securing member comprises at least two resilient elements extending from the body inside the holding space. The at least two resilient elements are positioned for gripping around the air pump when the air pump is arranged in the first position in the holding space.

In an embodiment of the housing according to the invention the housing the at least two resilient elements are positioned for gripping around the air pump from two opposing sides when the air pump is arranged in the first position in the holding space.

In order to further improve the positioning of the pump in the housing body, the resilient securing members may be provided with a number of resilient securing elements that are configured for gripping around the pump at different locations. For example, the securing elements may be arranged in any desired configuration, such as opposite one another, inline or any other suitable combination. For example, the securing means may be provided with a number of clamps located opposite one another and configured for gripping the pump at different locations.

In an embodiment of the housing according to the invention the body comprises a recess provided for at least partially positioning the air pump therein.

In an embodiment of the housing according to the invention a first section of the recess has a shape which is complementary to the shape of the air pump when the air pump is arranged in the first position in the holding space.

It has been found that by providing a recess in the housing, may further improve the positioning of the pump in the housing during operation. The positioning of the pump in the housing body may be further improved by providing the recess with a complimentary shape to that of the pump. In this way, the sidewalls of the recess may cooperate with the resilient securing member to hold the pump in the desired position, thereby preventing any unwanted movement of the pump during the pumping operation.

In an embodiment of the housing according to the invention a second section of the recess has a shape which is complementary to the shape of the air pump when the air pump is arranged in a second position in the holding space. In the second position an air inlet of the air pump is releasably connected to the second opening in an airtight manner.

In some cases, the recess may be provided with a second recess section, which is arranged for maintaining the position of the pump during a deflation operation. By providing the second section with a complimentary shape to the shape of the pump has the advantage of securing the pump in the desired position without the need for providing additional securing elements

In an embodiment of the housing according to the invention the resilient securing member is positioned at a location around the recess. Preferably, the resilient securing member is positioned at one or more locations along the edge of the recess.

In an embodiment of the housing according to the invention the resilient securing member is positioned at a location around the first section of the recess. Preferably, the resilient securing member is positioned at one or more locations along the edge of the first section of the recess.

It has been found that by providing the resilient securing elements around the first recess has the advantage of further ensuring the positioning of the pump during a pumping operation. In this way, the risk of the pump being unexpectedly dislodged from the housing is further minimised.

In an embodiment of the housing according to the invention the resilient securing member is provided such that sides of the resilient securing member which are in contact with the air pump, when the air pump is arranged in the first position in the housing, have a shape complementary to the shape of the air pump.

In order to further improve the grip of the resilient securing member on the pump body, the contact surfaces of the resilient securing members has a complimentary shape to that of the pump body.

In an embodiment of the housing according to the invention the housing comprises a cover element provided for sealing off the first opening of the housing.

In an embodiment of the housing according to the invention the cover element and the first opening are each provided with a complementary such that the cover element is screwable in the first opening for sealing off the first opening.

It has been found that by providing a cover for closing off the housing, it is ensured that the pump is not accidentally removed. The cover may cooperate with the opening of the housing to form a watertight barrier that prevents water or other liquids from entering into the housing. For example, the cover and the first opening of the housing may be provided with complimentary screw threads, so as to allow the cover to be screwed on the housing in a watertight manner. Alternative, the first opening and the cover may be provided with complimentary grooves, allowing the cover to slide over the first opening so as to form a watertight barrier. Additionally, a waterproof sealing member may be positioning between the cover and the first opening to further ensure that the housing remains waterproof.

In an embodiment of the housing according to the invention the cover element and the first opening have a circular shape.

It has been found that by providing the cover and the first opening with a circular shape ensures that the closing off of the housing remains relative simple while greatly enhancing its waterproofing properties.

In an embodiment of the housing according to the invention the housing comprises a third opening. The third opening is provided for forming, when the housing is incorporated in the inflatable device, a passage between the holding space and the inside of the inflatable device. The housing further comprises a plug for sealing the third opening.

By providing a third opening in the housing, which is closed off with a plug, has the advantage of allowing the inflatable device to be rapidly deflated. For example, in case of an emergency, the inflatable device can be deflated quickly and safely by pulling the plug from the third opening.

In an embodiment of the housing according to the invention the body is made of a flexible material. For example, the housing may be made from a plastic material, a plastic composite material or any other suitable material, in order to ensure the required flexibility without compromising the strength of the housing.

In an embodiment of the housing according to the invention the body is made as a single part.

The housing body, which includes the resilient securing member, is made as a single part, thereby greatly simplifying the manufacturing process in comparison to the device of the prior art.

In an embodiment of the housing according to the invention the housing comprises a check valve, i.e. a one-way valve, arranged in the second opening. The check valve, i.e. a one-way valve, is configured to allow air from being pumped from the holding space through the second opening.

The invention further provides an air pump for use with a housing according to the invention. The air pump comprises an air inlet and an air outlet. The air outlet of the air pump is provided for being releasably connected to the second opening of the housing in an airtight manner. In this way, air may be pumped in and/or out of the inflatable device in an easy and quick manner without requiring any manual intervention, e.g. the user holding the pump during the pumping operation.

In an embodiment of the air pump according to the invention the air inlet of the air pump is provided for being releasably connected to the second opening of the housing in an airtight manner.

In an embodiment of the air pump according to the invention, for use with the housing wherein the check valve is arranged in the second opening of the body of the housing, the air pump comprises a biasing element at the air inlet. The biasing element is provided for moving and holding the check valve into an open position when the air inlet of the air pump is releasably connected to the second opening of the housing in an airtight manner. In the open position air is allowed to flow through the second opening into the holding space.

It has been found that by providing a biasing element, it may have the advantage that the deflation of the inflatable device may be performed without the need for operating the pump.

In an embodiment of the air pump according to the invention the air pump comprises at least one battery for powering the air pump. In this way, the pump is highly portable and can be used together with a variety of inflatable devices, which may include inflatable devices that are not provided with a housing according to the previous embodiments.

In an embodiment of the air pump according to the invention the air pump comprises at least one USB-connector for charging the at least one battery. By enabling the pump to be charged via a USB-connector, it is possible to further simplify its design. In addition, the USB-connector allows the device to be charged from a variety of portable electronic devices e.g. laptops.

In an embodiment of the air pump according to the invention the air pump is a radial flow pump.

A radial flow pump offers a simple operation, where the only moving parts are the impeller and the shaft. As a result, it ensures quiet operation along with highly efficient operation, which contributes to the small pressure build up on the casing.

Use of the air pump according to embodiments of the present invention for inflating and/or deflating an inflatable device comprising at least one air valve. The main advantage of the pump is its portability. Because it can be easily removed from the housing of the inflatable device it can be used for inflating and/or deflating a variety of other inflatable devices, which may include devices that are not provided with housing according to embodiments of the present invention.

Use of the air pump according to claim 24 for inflating and/or deflating an inflatable device comprising a housing according to claims 1-17.

An air pump assembly for use with an inflatable device comprising an inlet valve, the air pump assembly comprising the air pump according to any one of the previous embodiments, and at least one adapter element for releasably connecting the air inlet and/or the air outlet of the air pump to the inlet valve of the inflatable device in an airtight manner.

The air pump assembly may be provided with a range of adapter, which can be attached to the air inlet or air outlet of the pump. In this way, the pump may be used with a variety of inflatable devices that may be provided with different types of air valves. For example, the pump may be used together with one of the adapter elements to pump an inflatable bed that is not provided with the housing of the present invention.

The invention further provides an inflatable device comprising the housing according to the invention. The housing may be incorporated in a side wall of the inflatable device which surrounds an inflatable volume of the inflatable device.

The invention further provides an inflatable device assembly comprising an inflatable device comprising at least one air valve and an air pump according to embodiments of the present invention or an air pump assembly according to embodiments of the present invention. The invention further provides an inflatable device assembly comprising an inflatable device according to embodiments of the present invention.

### BRIEF DESCRIPTION OF THE DRAWINGS

The invention will be further elucidated by means of the following description and the appended figures.

FIG. 1 shows an example of an inflatable device provided with a housing according to embodiments of the present invention.

FIG. 2 shows an example of a housing for holding an air pump according to embodiments of the present invention.

FIGS. 3a-3b show different aspects of the housing of FIG. 2.

FIGS. 4a-4d show different aspects of an exemplified housing according to embodiments of the present invention.

FIG. 5 shows different views of an exemplified cover for the housing shown in FIGS. 4a-4d.

FIG. 6 shows different views of an exemplified pump according to embodiments of the present invention.

FIG. 7 shows a cross-sectional view of the pump of FIG. 6.

FIG. 8 shows different views of a pump incorporated in a housing according to embodiments of the present invention.

### MODES FOR CARRYING OUT THE INVENTION

The invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the invention, the only relevant components of the device are A and B.

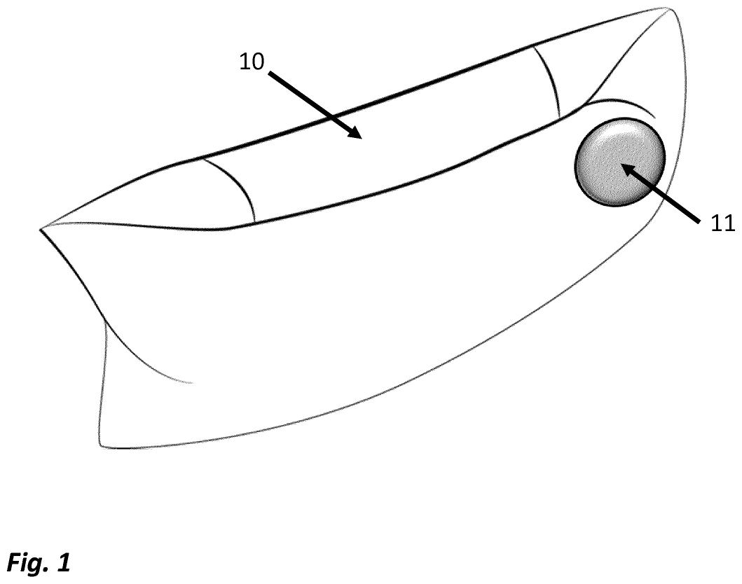

The present invention will be described with references with references to the examples shown in FIGS. 1 to 8.

FIG. 1 shows an example of an inflatable device 10 incorporating a housing 11, also referred to as shell, for holding an air pump 22 according to embodiments of the present invention. The exemplified inflatable device 10 shown in FIG. 1 is lounge seat that can be used either indoors or outdoors for a variety of purposes. The inflatable device 10 may be made from a light weight airtight material, which forms an inflatable volume. The inflatable volume may be filled with air or another preferred gas. The inflatable device 10 may be provided with a housing 11 for holding an air pump 22, which may be used for inflating and/or deflating the inflatable device 10. The housing 11 may be provided in any desired shape, such as circular, square, etc.

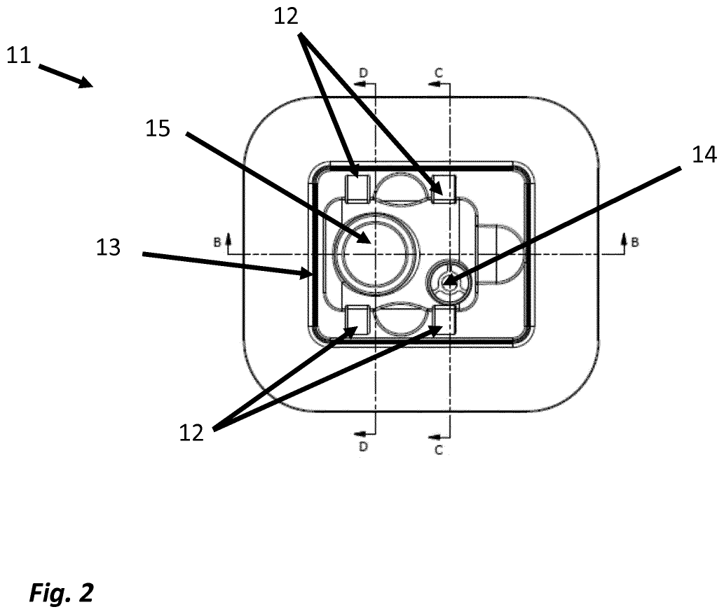

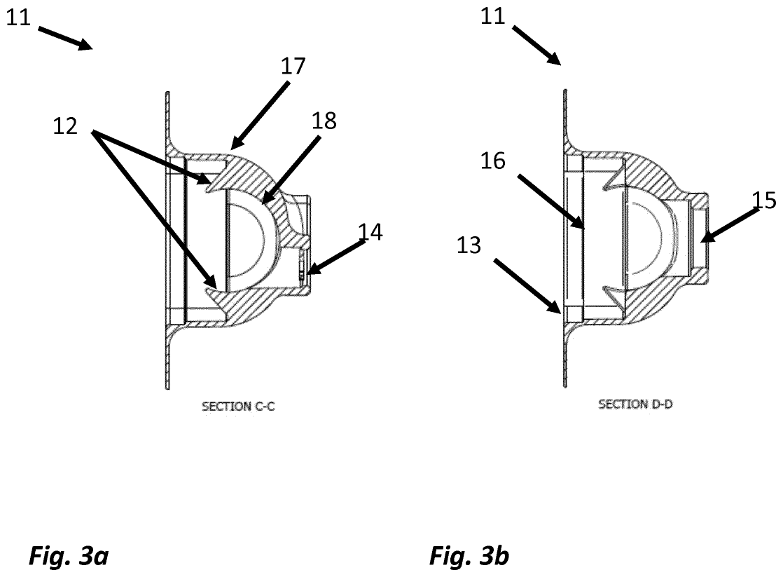

FIGS. 2 and 3 show different views of an exemplified housing 11 for holding an air pump 22 according to embodiments of the present invention. The housing is provided for being incorporated in an inflatable device 10, such as the one shown in FIG. 1. The housing 11 is provided with a housing body 17 defining a holding space 16 for holding an air pump 22. The housing 11 comprises a first opening 13, through which the pump can be taken in and out of the holding space 16. The first opening 13 may be located in a first side face of the body 17. The housing 11 may be provided with a second opening 14 in a second side face of the body 17. The second opening 14 may be provided for forming, when the housing 11 is incorporated in the inflatable device 10, a passage between the holding space 16 of the housing 11 and the inflatable volume of the inflatable device 10. The second opening 14 may be releasably connected to the air pump 22 in an airtight manner, so that air can be pumped in and or pumped out of the inflatable device 10. The second opening 14 may be provided with an air valve through which air or another gaseous substance may be pumped in and/or pumped out. For example, the a check valve may be provided in the second opening 14 to allow air being pumped in, by means of the air pump 22, from the holding space through the second opening. The housing body 17 may be provided with a resilient securing member in the holding space 16 for releasably securing the air pump 22 in the housing 11. The resilient securing member may be provided with at least one resilient securing element 12 configured for securing the air pump 22 in the holding space 16, when the air pump is in a first position in the holding space. In the first position, an air outlet 24 of the air pump 22 is releasably connected to the second opening 14 in an airtight manner. As shown in FIGS. 3a and 3b, two resilient securing elements 12 may be provided, which extend from the housing body 17 inside the holding space 16. The securing elements 12 are configured for gripping around the body of the air pump 22, when the pump is the first position. As shown in FIG. 2, the securing elements 12 may be provided on two opposing sides, so as to better grip the air pump 22, when the air pump 22 is arranged in the first position in the holding space 16. As shown in FIGS. 2 and 3, the holding space 16 may be provided with a recess 18 comprising a first section of receiving the air pump 22. The first section 18a may be provided with a shape complimentary to that of the air pump 22, so as to ensure that the air pump 22 is better secured into the first position during the pumping operation. The resilient securing elements 12 may be designed such that they extend from the area around the first section 18a of the recess 18. In this way, the recess 18 in cooperation with the resilient securing elements 12 may better secure the air pump 22 during the pumping operation. The housing body 17 may be provided with a third opening 15 that forms, when the housing is incorporated in the inflatable device, a passage between the holding space 16 of the housing 11 and the inflatable volume of the inflatable device 10. The passage allows air or another gaseous substance to flow between the inflatable volume and the holding space 16. The third opening may be sealed by means of a plug, thereby preventing air to escape from the inflatable volume. In case of a quick deflation is necessary, the plug may be pulled off so as to allow air to escape from the inflatable volume.

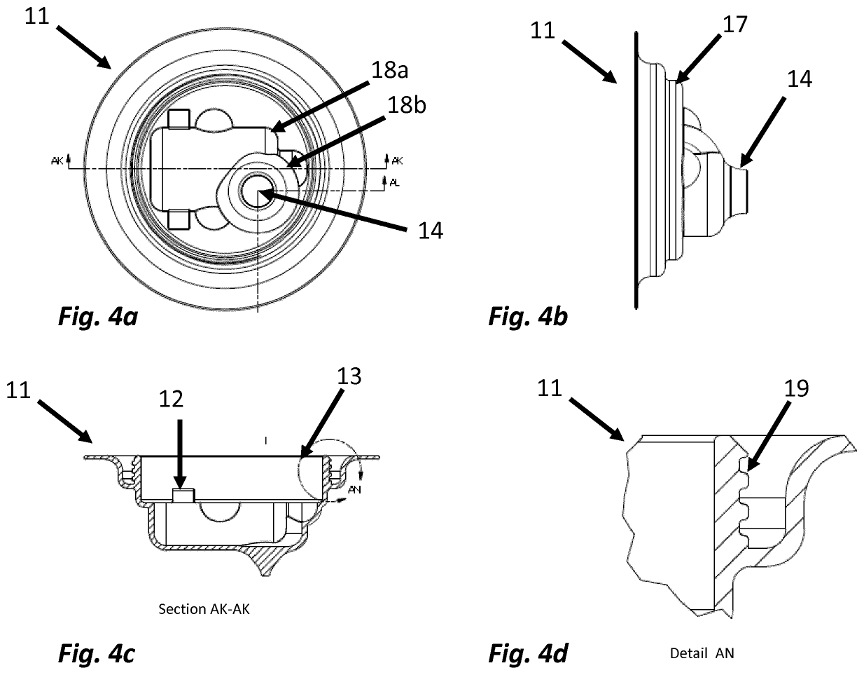

FIGS. 4a-4d show different views of housing 11 for holding an air pump 22 according to embodiments of the present invention. The housing 11 of FIGS. 4a-4d is substantial similar to the housing 11 presented in FIGS. 2 and 3a-3b, thus only the main differences will be explained. The housing 11, as shown in FIG. 4a, has a substantial circular shape. The first opening 13 is provided with screw threads 19 configured for cooperating with a cover 21 having complementary screw threads 20, as shown in FIGS. 4c and 4d. The housing 11 is provided with a recess 18 having a first section 18a and a second section 18b. The first section 18a has a complimentary shape to the shape of the pump when positioned in a first pumping position. For example, in the first pumping position the air pump 22 may be connected to the valve of the second opening 15 for pumping air in the inflatable volume. The second section 18b has a complimentary shape to the shape of the air pump 22, when positioned in a second pumping position. For example, in the second pumping position the air pump 22 may be positioned upright in the second recess section 18b for deflating the inflatable device 11. As previously, the resilient securing elements 12 may extend outwards from the housing body 17 at a location around the first recess section 18a.

According to embodiments of the present invention, the housing 11 may be made as a single part e.g. using a moulding process, thus greatly simplifying the manufacturing and assembly process. The housing 11 may be made from a plastic material or a composite plastic material so as to maintain the required strength and flexibility characteristics.

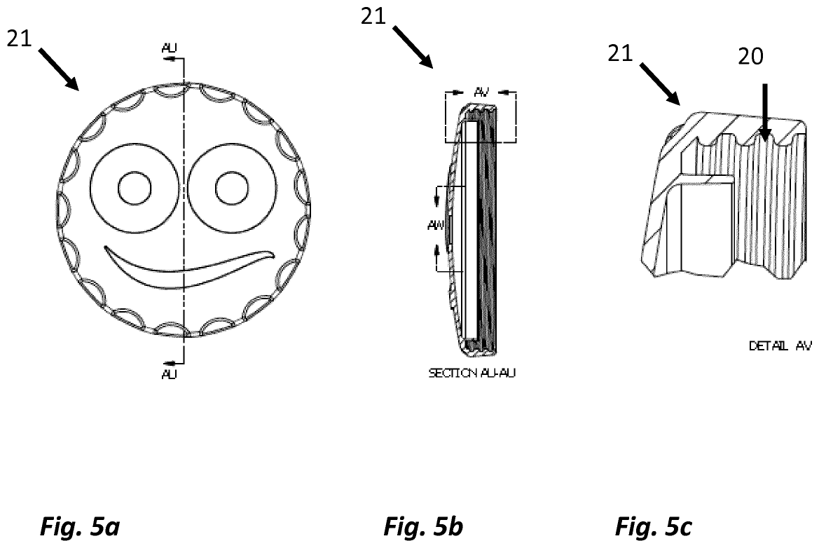

As shown in FIGS. 5a-5c a cover 21 may be provided for closing off the first opening 13 of the housing 11. The cover 21 may be provided, as shown in FIGS. 4b and 4c, with complimentary screw threads 20 to the screw thread 19 of the first opening 13 e.g. the first opening 13 shown in FIGS. 4a-4d. The complimentary screw threads 20 allow the cover 21 to be screwed to the first opening 13 so as to prevent water or dust from entering the holding space 16 of the housing. In this way, it is ensured that damage to the air pump 22 or any other part of the housing 11 is prevented, when the inflatable device 10 is used outdoors e.g. sandy beaches, water, snow, etc. The cover 21 may have a circular shape, as shown in FIGS. 5a-5c. However, it should be noted that any other first opening 13 and the cover 21 may take any other desirable shape. Also it should be noted, that the cover 21 may be attached to the first opening 13 in a number of ways. For example, the first opening 13 and the cover 21 may be provided with complementary grooves, which are not shown, that allow the cover to close off the first opening 13 so as to prevent water or dust from entering the holding space 16. Also a sealing member may be provided between the first opening 13 and the cover 21 so as to prevent water or dust from entering the holding space 16.

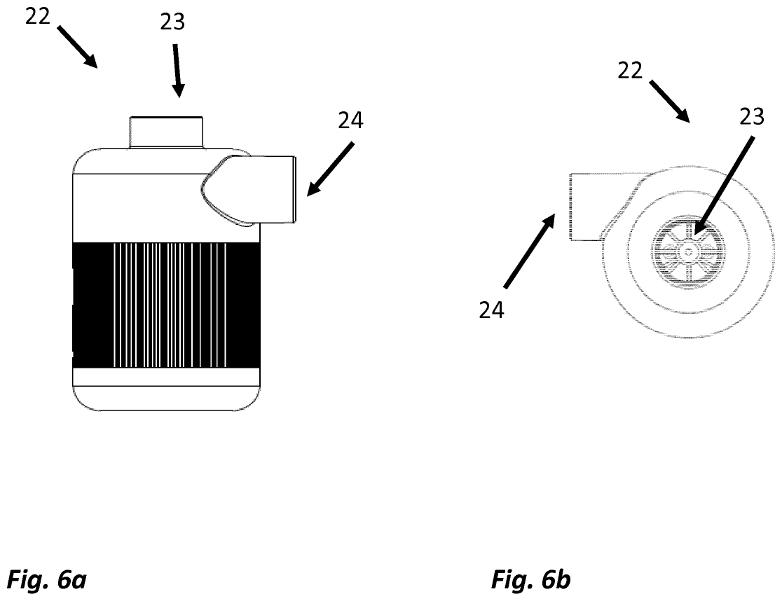

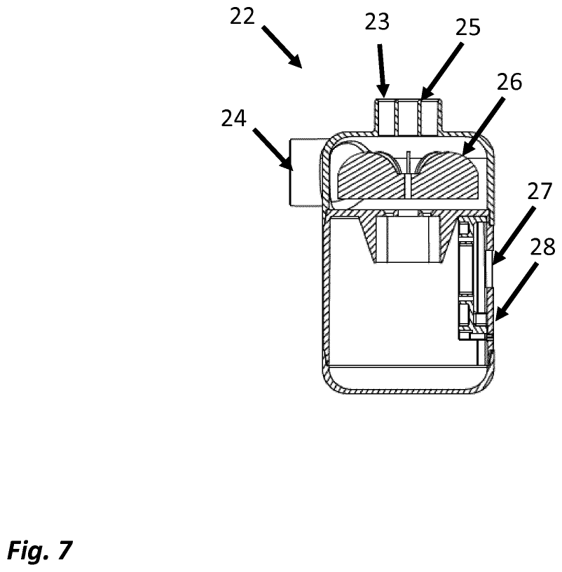

An air pump 22 according to the present invention is shown in FIGS. 6a and 6b. The air pump 22 comprises an air inlet port 23, through which air is drawn in by means of an impellor 26, and an air outlet port 24, through which air is expeller out from the air pump 22. As shown in FIG. 7, which is a cross-sectional view of the air pump 22 of FIGS. 6a and 6b, the air pump 22 may be provided in the air inlet port 23 with a biasing element 25. The biasing element 25 may be a piece of hollow plastic that extends from the base of the air inlet 23. The air pump 22 may be a radial pump comprising an impellor 25 for drawing in air, which is subsequently expelled via the air outlet port 24. The air pump 22 may further comprise a power switch 26 for switching on and off the air pump 22. A USB charging connector 27 may be further provided for charging the battery of the air pump 22. The USB-connector 27 may be used for charging the battery of the air pump 22 by drawing current from a portable electronic device, e.g. laptop, thus allowing the air pump 22 to be charged when the inflatable device is used outdoors.

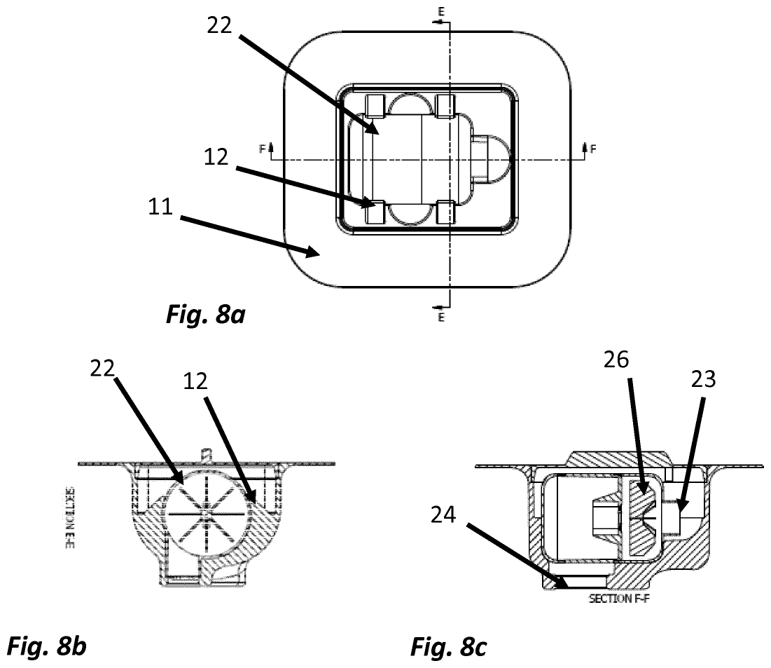

The air pump 22 may be used for inflating and or deflating an inflatable device 10 having a housing 11 according to embodiments of the present invention. As shown in FIGS. 8a-8c, the air pump 22 may be positioned in the first pumping position, whereby the air outlet 24 of the air pump may be releasably connected to the air valve of the second opening 15. In the first pumping position, the air pump 22 is secured in the first section 18a of the recess 18 by the resilient securing members 12. The resilient securing members 12 may be configured for gripping at a location around the air pump 22 body, as shown in FIGS. 8a to 8c. As shown in FIGS. 4b and 4c, in the first position the air pump 22 may be arranged for inflating the inflatable device 10 by drawing air in through the air inlet 23, which is subsequently is pumped through the air outlet 24 to the inflatable volume via the air valve provided in the second opening 15. The air pump 22 may also be used for deflating the inflatable device 10. The deflation may be performed by positioning the air pump 22 in the second recess section 18b, such that the air inlet 23 is releasably connected to the second opening. In the second position, the biasing element 25 may be arranged for pushing the air valve, also may be referred to as check valve, in the open position so as to allow air to escape from the inflatable volume into the holding space 16, thereby deflating the inflatable device 10.

It should be noted that the air pump 22 of the present invention may be used for inflating and/or deflating inflatable device having an air valve but not necessarily provided with the housing 11. For example, the air pump 22 may be used for inflating an air mattress, a ball, an air chair, etc. For this purpose, the air pump 22 may be provided with at least one adaptor element, each configured for allowing the air pump 22 for being connected to predetermine air valve of an inflatable device 10.

### LIST OF REFERENCE NUMBERS

10 Inflatable device
11 housing for holding an air pump
12 resilient securing elements
13 first opening
14 second opening
15 third opening
16 holding space
17 housing body
18 recess
18a first recess section
18b second recess section
19 first opening screw threads
20 cover screw threads
21 cover element
22 air pump
23 air inlet
24 air outlet
25 biasing element
26 impellor
27 power switch
28 USB-connector

1. A housing for holding an air pump, wherein the housing is configured to be incorporated in an inflatable device, the housing comprising:
a body defining a holding space for the air pump;
a first opening in a first side face of the body, the first opening being configured to allow the air pump to pass therethrough; and
a second opening in a second side face of the body, wherein when the housing is incorporated in the inflatable device, the second opening forms a passage between the holding space and an inflatable volume of the inflatable device, wherein the second opening is releasably connectable to the air pump in an airtight manner;
wherein the body comprises a resilient securing member in the holding space that is configured to releasably secure the air pump in the housing when the air pump is arranged in a first position in the holding space, in which first position an air outlet of the air pump is releasably connected to the second opening in an airtight manner.

2. The housing according to claim 1, wherein the resilient securing member comprises at least one resilient securing element extending from the body inside the holding space, wherein the at least one resilient securing element is configured to grip around the air pump when the air pump is arranged in the first position in the holding space.

3. The housing according to claim 1, wherein the resilient securing member comprises at least two resilient securing elements extending from the body inside the holding space, wherein the at least two resilient securing elements are configured to grip around the air pump when the air pump is arranged in the first position in the holding space.

4. The housing according to claim 3, wherein the at least two resilient securing elements are configured to grip around the air pump from two opposing sides when the air pump is arranged in the first position in the holding space.

5. The housing according to claim 1, wherein the body comprises a recess configured for at least partially positioning the air pump therein.

6. The housing according to claim 5, wherein a first section of the recess has a first shape which is complementary to a shape of the air pump when the air pump is arranged in the first position in the holding space, and wherein a second section of the recess has a second shape which is complementary to the shape of the air pump when the air pump is arranged in a second position in the holding space, in which second position an air inlet of the air pump is releasably connected to the second opening in an airtight manner.

7. (canceled)

8. The housing according to claim 5, wherein the resilient securing member is positioned at a location around the recess.

9. (canceled)

10. The housing according claim 1, wherein the resilient securing member is configured such that sides of the resilient securing member which are in contact with the air pump, when the air pump is arranged in the first position in the housing, have a shape complementary to a shape of the air pump.

11. The housing according to claim 1, wherein the housing comprises a cover element configured to seal off the first opening of the housing.

12-13. (canceled)

14. The housing according to claim 1, wherein the housing comprises a third opening, wherein the third opening is configured to form, when the housing is incorporated in the inflatable device, a second passage between the holding space and the inside of the inflatable device, and wherein the housing further comprises a plug configured to seal the third opening.

15-16. (canceled)

17. The housing according to claim 1, wherein the housing comprises a check valve arranged in the second opening, the check valve being configured to allow air to be pumped from the holding space through the second opening.

18. An air pump for use with the housing according to claim 1, wherein the air pump comprises an air inlet and an air outlet, wherein the air outlet of the air pump is configured to releasably connect to the second opening of the housing in an airtight manner.

19. The air pump according to claim 18, wherein the air inlet of the air pump is configured to releasably connect to the second opening of the housing in an airtight manner.

20. The air pump according to claim 19, wherein the air pump comprises a biasing element at the air inlet, wherein the biasing element is configured to move and hold a check valve in the second opening into an open position when the air inlet of the air pump is releasably connected to the second opening of the housing in an airtight manner, in which open position air is allowed to flow through the second opening into the holding space.

21-22. (canceled)

23. The air pump according to claim 18, wherein the air pump is a radial flow pump.

24. A method of using the air pump of claim 18, comprising: inflating or deflating an inflatable device comprising at least one air valve.

25. (canceled)

26. An air pump assembly for use with an inflatable device comprising an inlet valve, the air pump assembly comprising:
the air pump according to claim 18; and
at least one adapter element configured to releasably connect at least one of the air inlet or the air outlet of the air pump to the inlet valve of the inflatable device in an airtight manner.

27. An inflatable device comprising the housing according to claim 1.

28. An inflatable device according to claim 27, wherein the housing is incorporated in a side wall of the inflatable device which surrounds the inflatable volume of the inflatable device.

29. An inflatable device assembly comprising an inflatable device comprising at least one air valve and an air pump according to claim 18.

30. (canceled)
